(19) United States
(12) Patent Application Publication
(10) Pub. No.: US 2023/0132520 A1
(43) Pub. Date: May 4, 2023

(54) ROTATING ELECTRICAL MACHINE AND DRIVE DEVICE

(71) Applicant: NIDEC CORPORATION, Kyoto (JP)

(72) Inventors: Keisuke NAKATA, Kyoto (JP); Yuki ISHIKAWA, Kyoto (JP); Sota DOI, Kyoto (JP); Kouhei OBA, Kyoto (JP)

(21) Appl. No.: 17/969,689

(22) Filed: Oct. 20, 2022

(30) Foreign Application Priority Data
Oct. 29, 2021 (JP) 2021-177844

(51) Int. Cl. H02K 5/173; H02K 5/20

(52) U.S. Cl. CPC H02K 5/1732; H02K 5/203

(57) ABSTRACT

A rotating electrical machine includes an electricity removal device in electrical contact with a shaft and a housing, a channel, a nozzle having a through hole communicating with an inside of the shaft, and a seal radially between the shaft and the housing. The shaft includes a hollow first portion and a second portion having a lid on a first side of the first portion and an extension extending from the lid to the first side. The extension axially passes through the through hole. The device is in contact with the extension on the first side relative to the through hole. The seal is on the first side relative to the nozzle and on the second side relative to the device. The shaft includes a channel communicating the first portion and the through hole. The channel opens toward an axial gap between the nozzle and the seal of the housing.

### CROSS-REFERENCE TO RELATED APPLICATIONS

The present invention claims priority under 35 U.S.C. § 119 to Japanese Patent Application No. 2021-177844 filed on Oct. 29, 2021, the entire content of which is incorporated herein by reference.

### FIELD OF THE INVENTION

The present invention relates to a rotating electrical machine and a drive device.

### BACKGROUND

There is known a charge dissipation device that dissipates charges from a shaft of a rotating electrical machine. For example, a current shunt ring having a conductive segment in contact with the shaft is conventionally known.

In a rotating electrical machine including the charge dissipation device as described above, there is a case where a fluid is supplied to a rotor, a stator, and the like for the purpose of cooling, for example. In this case, when the fluid is applied to the charge dissipation device, the conductivity of the charge dissipation device is reduced, and the charge is hardly dissipated in some cases.

### SUMMARY

One aspect of an exemplary rotating electrical machine of the present invention includes: a rotor having a hollow shaft rotatable about a central axis; a stator opposing the rotor with a gap interposed therebetween; a housing internally accommodating the rotor and the stator; a bearing rotatably supporting the shaft; an electricity removal device fixed to the housing and in electrical contact with the shaft and the housing; a housing channel portion provided in the housing; a nozzle member having a nozzle through hole communicating with an inside of the shaft; and a seal member positioned between the shaft and the housing in a radial direction. The shaft includes a hollow first shaft portion, and a second shaft portion having a lid portion provided in a portion on a first axial side of the first shaft portion and an extension portion extending from the lid portion to the first axial side. The extension portion is axially passed through the nozzle through hole. The electricity removal device is in contact with a portion of the extension portion positioned on the first axial side relative to the nozzle through hole. The seal member is positioned on the first axial side relative to the nozzle member and on the second axial side relative to the electricity removal device. The shaft includes a connection channel portion communicating with an inside of the first shaft portion and an inside of the nozzle through hole. The housing channel portion opens toward an axial gap between the nozzle member and the seal member of an inside of the housing.

One aspect of an exemplary drive device of the present invention includes the above rotating electrical machine and a gear mechanism connected to the rotating electrical machine.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is an outline configuration diagram schematically illustrating a drive device of an embodiment;

FIG. 2 is a cross-sectional view illustrating a part of a rotating electrical machine of an embodiment;

FIG. 3 is a perspective view illustrating a part of a motor housing of an embodiment, a part of a second shaft portion, and an electricity removal device;

FIG. 4 is an exploded perspective view illustrating a second shaft portion and a nozzle member of an embodiment; and

FIG. 5 is an exploded perspective view illustrating a second shaft portion and a nozzle member of an embodiment, and is a view of each member viewed from an angle different from that in FIG. 4.

### DETAILED DESCRIPTION

The following description will be made with a vertical direction being defined on the basis of positional relationships in the case where a drive device of embodiments is equipped in a vehicle positioned on a horizontal road surface. That is, it is sufficient that the relative positional relationships regarding the vertical direction described in the following embodiments are satisfied at least in the case where the drive device is equipped in the vehicle positioned on the horizontal road surface.

In the drawings, an XYZ coordinate system is illustrated appropriately as a three-dimensional orthogonal coordinate system. In the XYZ coordinate system, a Z-axis direction corresponds to the vertical direction. An arrow in the Z-axis is directed toward a side (+Z side) that is an upper side in the vertical direction, and a side (−Z side) opposite to the side toward which the arrow in the Z-axis is directed is a lower side in the vertical direction. In the following description, the upper side and the lower side in the vertical direction will be referred to simply as the “upper side” and the “lower side”, respectively. An X-axis direction is orthogonal to the Z-axis direction and corresponds to a front-rear direction of the vehicle equipped with the drive device. In the following embodiments, a side (+X side) toward which an arrow in the X-axis is directed is a front side in the vehicle, and a side (−X side) opposite to the side toward which the arrow in the X-axis is directed is a rear side in the vehicle. A Y-axis direction is a direction orthogonal to both the X-axis direction and the Z-axis direction and corresponds to a left-right direction of the vehicle, i.e., a vehicle lateral direction. In the following embodiments, a side (+Y side) toward which an arrow in the Y-axis is directed is a left side in the vehicle, and a side (−Y side) opposite to the side toward which the arrow in the Y-axis is directed is a right side in the vehicle. Each of the front-rear direction and the left-right direction is a horizontal direction orthogonal to the vertical direction.

A positional relationship in the front-rear direction is not limited to the positional relationship of the following embodiments. The side (+X side) toward which the arrow in the X-axis is directed may be the rear side in the vehicle, and the side (−X side) opposite to the side toward which the arrow in the X-axis is directed may be the front side in the vehicle. In this case, the side (+Y side) toward which the arrow in the Y-axis is directed is the right side in the vehicle, and the side (−Y side) opposite to the side toward which the arrow in the Y-axis is directed is the left side in the vehicle. In the present description, a “parallel direction” includes a substantially parallel direction, and an “orthogonal direction” includes a substantially orthogonal direction.

A central axis J illustrated in the drawings as appropriate is a virtual axis extending in a direction intersecting the vertical direction. More specifically, the central axis J extends in the Y-axis direction orthogonal to the vertical direction, i.e., in the left-right direction of the vehicle. In description below, unless otherwise particularly stated, a direction parallel to the central axis J is simply referred to as “axial direction”, a radial direction about the central axis J is simply referred to as “radial direction”, and a circumferential direction about the central axis J, i.e., a direction about the central axis J is simply referred to as “circumferential direction”. In the following embodiments, the right side (−Y side) is referred to as “first axial side”, and the left side (+Y side) is referred to as “second axial side”.

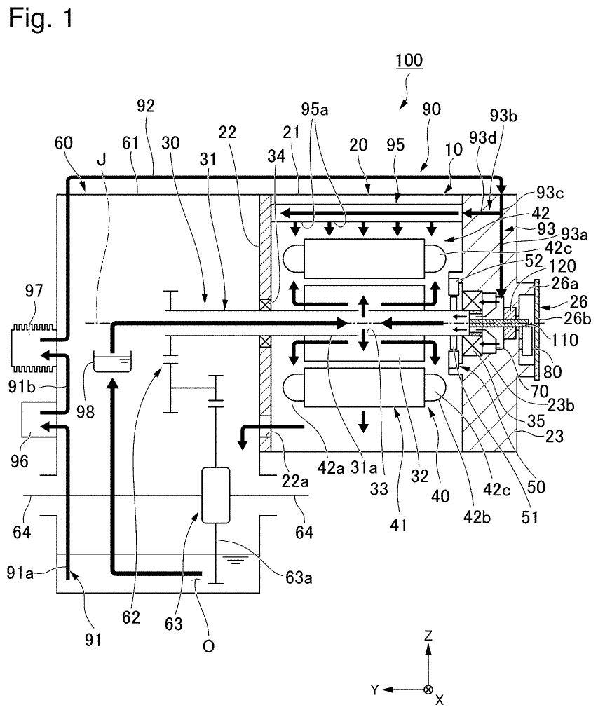

A drive device 100 of the present embodiment illustrated in FIG. 1 is a drive device that is equipped in a vehicle and rotates an axle 64. The vehicle equipped with the drive device 100 is a vehicle including a motor as a power source, such as a hybrid vehicle (HEV), a plug-in hybrid vehicle (PHV), or an electric vehicle (EV). As illustrated in FIG. 1, the drive device 100 includes a rotating electrical machine 10 and a gear mechanism 60. The gear mechanism 60 is connected to the rotating electrical machine 10 and transmits the rotation of the rotating electrical machine 10, that is, the rotation of a rotor 30 described later to the axle 64 of the vehicle. The gear mechanism 60 of the present embodiment includes a gear housing 61, a speed reducer 62 connected to the rotating electrical machine 10, and a differential gear 63 connected to the speed reducer 62.

The gear housing 61 internally accommodates the speed reducer 62, the differential gear 63, and oil O. The oil O is stored in a lower region in the gear housing 61. The oil O circulates in a refrigerant channel portion 90 described later. The oil O is used as a refrigerant for cooling the rotating electrical machine 10. The oil O is also used as lubricating oil for the speed reducer 62 and the differential gear 63. As the oil O, for example, an oil equivalent to an automatic transmission fluid (ATF) having a relatively low viscosity is preferably used to function as a refrigerant and lubricating oil.

The differential gear 63 includes a ring gear 63a. Torque output from the rotating electrical machine 10 is transmitted the ring gear 63a through the speed reducer 62. The ring gear 63a has a lower end portion immersed in the oil O stored in the gear housing 61. When the ring gear 63a rotates, the oil O is scraped up. The oil O scraped up is supplied to, for example, the speed reducer 62 and the differential gear 63 as lubricating oil.

The rotating electrical machine 10 is a portion that drives the drive device 100. The rotating electrical machine 10 is positioned, for example, on a first axial side (−Y side) of the gear mechanism 60. In the present embodiment, the rotating electrical machine 10 is a motor. The rotating electrical machine 10 includes a motor housing 20, the rotor 30 having a shaft 31, bearings 34 and 35 that rotatably support the rotor 30, a stator 40, a resolver 50, a nozzle member 70, an electricity removal device 80, and a seal member 120. The bearings 34 and 35 are each a ball bearing, for example.

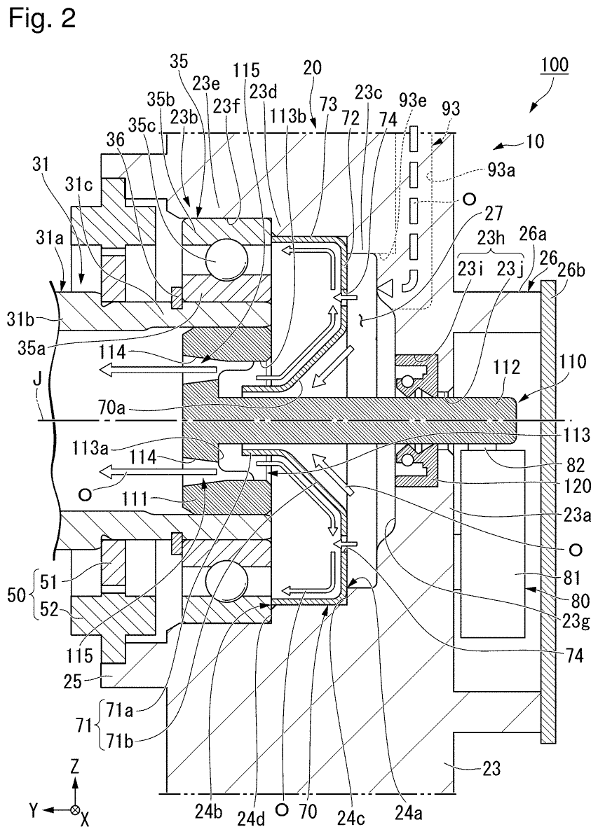

In the present embodiment, the bearings 34 and 35 are ceramic ball bearings. The bearing 34 rotatably supports a portion of the shaft 31 positioned on the second axial side (+Y side) relative to the stator 40. The bearing 35 rotatably supports a portion of the shaft 31 positioned on the first axial side (−Y side) relative to the stator 40. As illustrated in FIG. 2, the bearing 35 includes an inner ring 35a having an annular shape about the central axis J, an outer ring 35b having an annular shape about the central axis J and positioned radially outside the inner ring 35a, and a plurality of balls 35c positioned radially between the inner ring 35a and the outer ring 35b. The configuration of the bearing 34 is similar to the configuration of the bearing 35.

The motor housing 20 is a housing that internally accommodates the rotor 30 and the stator 40. The motor housing 20 communicates with the gear housing 61 on the first axial side (−Y side). The motor housing 20 has a body portion 21, a partition wall portion 22, and a motor cover 23. The body portion 21 and the partition wall portion 22 are each, for example, a part of an identical single member. The motor cover 23 is separate from, for example, the body portion 21 and the partition wall portion 22.

The body portion 21 is in a tubular shape that surrounds the central axis J and opens on the first axial side (−Y side). The partition wall portion 22 communicates with an end portion of the body portion 21 on the second axial side (+Y side). The partition wall portion 22 axially partitions the inside of the motor housing 20 and the inside of the gear housing 61. The partition wall portion 22 has a partition wall opening 22a that allows the inside of the motor housing 20 and the inside of the gear housing 61 to communicate with each other. The partition wall portion 22 holds the bearing 34. The motor cover 23 is fixed to an end portion of the body portion 21 on the first axial side. The motor cover 23 closes an opening of the body portion 21 on the first axial side. The motor cover 23 holds the bearing 35.

As illustrated in FIG. 2, the motor cover 23 has a hole portion 23f recessed from a surface on the second axial side (+Y side) to the first axial side (−Y side) of the motor cover 23. The hole portion 23f is a hole that has a bottom portion on the first axial side and opens on the second axial side. In the present embodiment, the hole portion 23f is a circular hole about the central axis J. Providing the hole portion 23f provides the motor cover 23 with a bottom wall portion 23a and a peripheral wall portion 23b. That is, the motor housing 20 includes the bottom wall portion 23a and the peripheral wall portion 23b.

The bottom wall portion 23a is the bottom portion of the hole portion 23f. A surface of the bottom wall portion 23a on the second axial side (+Y side) is provided with a second recess portion 23g recessed on the first axial side. When viewed axially, the inner edge of the second recess portion 23g has a circular shape about the central axis J.

The peripheral wall portion 23b protrudes from a radially outer peripheral edge portion of the bottom wall portion 23a on the second axial side (+Y side). The peripheral wall portion 23b surrounds the shaft 31. The peripheral wall portion 23b has an inner peripheral surface that is an inner peripheral surface of the hole portion 23f. In the present embodiment, the inner peripheral surface of the peripheral wall portion 23b has a cylindrical shape about the central axis J.

The peripheral wall portion 23b includes a first wall portion 23c, a second wall portion 23d, and a third wall portion 23e. The first wall portion 23c is a portion communicating with a radially outer peripheral edge portion of the bottom wall portion 23a. The second wall portion 23d communicates with the first wall portion 23c on the second axial side (+Y side). The second wall portion 23d has a larger inner diameter than that of the first wall portion 23c. The second wall portion 23d has a larger axial dimension than that of the first wall portion 23c. The third wall portion 23e communicates with the second wall portion 23d on the second axial side. The third wall portion 23e has a larger inner diameter than that of the second wall portion 23d. The third wall portion 23e has a larger axial dimension than that of the second wall portion 23d. The bearing 35 is held on the radially inner side the third wall portion 23e. That is, the bearing 35 is held in the peripheral wall portion 23b. The outer ring 35b of the bearing 35 is fitted to the radially inner side of the third wall portion 23e.

In the present embodiment, the inner peripheral surface of the peripheral wall portion 23b has a first stepped portion 24a and a second stepped portion 24b. The first stepped portion 24a is a step provided axially between an inner peripheral surface of the first wall portion 23c and an inner peripheral surface of the second wall portion 23d. The first stepped portion 24a has a first stepped surface 24c facing the second axial side (+Y side). The first stepped surface 24c has an annular shape about the central axis J. The first stepped surface 24c is a flat surface orthogonal to the axial direction. The second stepped portion 24b is a step provided axially between an inner peripheral surface of the second wall portion 23d and an inner peripheral surface of the third wall portion 23e. The second stepped portion 24b has a second stepped surface 24d facing the second axial side. The second stepped surface 24d has an annular shape about the central axis J. The second stepped surface 24d is a flat surface orthogonal to the axial direction. The bearing 35 held in the third wall portion 23e is in contact with the second stepped surface 24d. Therefore, the bearing 35 can be suitably positioned axially with respect to the motor housing 20. More specifically, the outer ring 35b of the bearing 35 is in contact with the second stepped surface 24d from the second axial side.

A surface of the motor cover 23 on the second axial side (+Y side) is provided with a resolver holding portion 25. In the present embodiment, the resolver holding portion 25 is provided on the peripheral edge portion of the hole portion 23f of the surface of the motor cover 23 on the second axial side. The resolver holding portion 25 extends in the circumferential direction and surrounds the shaft 31.

The motor housing 20 has a through hole 23h axially penetrating the bottom wall portion 23a. The through hole 23h is a circular hole about the central axis J. The through hole 23h has a large-diameter hole portion 23i and a small-diameter hole portion 23j. The large-diameter hole portion 23i is open to the bottom surface of the second recess portion 23g of the surface on the second axial side (+Y side) of the bottom wall portion 23a. The small-diameter hole portion 23j communicates with the first axial side (−Y side) of the large-diameter hole portion 23i via a step. The inner diameter of the small-diameter hole portion 23j is smaller than the inner diameter of the large-diameter hole portion 23i. The small-diameter hole portion 23j opens on the surface on the first axial side of the bottom wall portion 23a. The axial dimension of the small-diameter hole portion 23j is smaller than the axial dimension of the large-diameter hole portion 23i.

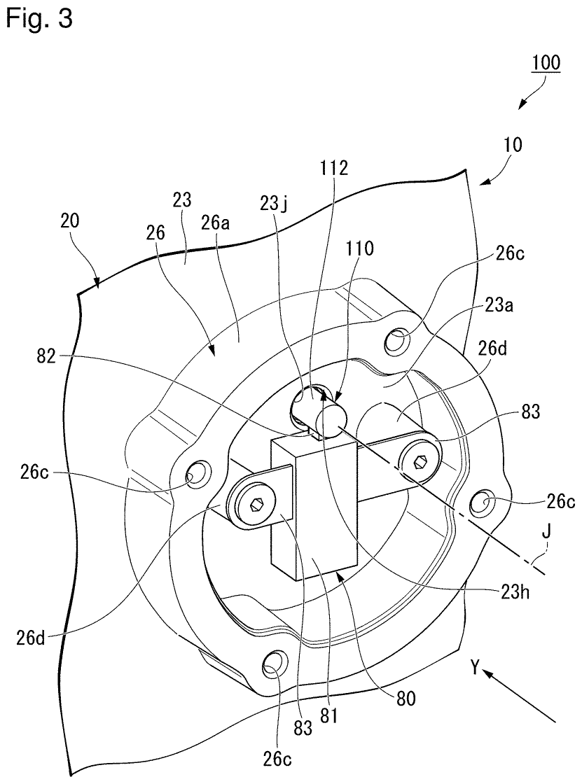

The motor housing 20 includes an accommodation portion 26 that internally accommodates the electricity removal device 80. The accommodation portion 26 is provided on a surface of the first axial side (−Y side) of the motor cover 23. The accommodation portion 26 protrudes from the motor cover 23 to the first axial side. The accommodation portion 26 includes a tubular portion 26a and a lid body 26b. The tubular portion 26a protrudes from the surface on the first axial side of the motor cover 23 to the first axial side. As illustrated in FIG. 3, the tubular portion 26a has a substantially cylindrical shape that opens on the first axial side. The central axis of the tubular portion 26a is parallel to the central axis J of the rotating electrical machine 10 and is provided at a position eccentric in the radial direction with respect to the central axis J. The central axis of the tubular portion 26a is positioned lower than the central axis J, for example.

The tubular portion 26a surrounds the through hole 23h when viewed axially. When viewed axially, a part of the bottom wall portion 23a is positioned inside the tubular portion 26a. In the present embodiment, the tubular portion 26a and the motor cover 23 are a part of an identical single member. The tubular portion 26a has a plurality of female screw holes 26c. The plurality of female screw holes 26c are provided on the surface on the first axial side (−Y side) of the tubular portion 26a.

As illustrated in FIG. 2, the lid body 26b is fixed to the first axial side (−Y side) of the tubular portion 26a. Although not illustrated, the lid body 26b is fixed to the tubular portion 26a by bolts respectively tightened into the plurality of female screw holes 26c. The lid body 26b has a plate shape whose plate surface faces the axial direction.

As illustrated in FIG. 3, the motor housing 20 has a support column portion 26d. The support column portion 26d protrudes to the first axial side from a portion positioned inside the tubular portion 26a when viewed axially of the surface on the first axial side (−Y side) of the motor cover 23. The support column portion 26d has a columnar shape. The support column portion 26d is positioned in the accommodation portion 26. A pair of support column portions 26d are provided at intervals in a direction orthogonal to the axial direction. When viewed axially, the through hole 23h is not positioned between the pair of support column portions 26d. That is, the through hole 23h is disposed to be shifted in a direction orthogonal to the axial direction from between the pair of support column portions 26d.

As illustrated in FIG. 1, the rotor 30 includes the shaft 31 and a rotor body 32. Although not illustrated, the rotor body 32 includes a rotor core, and a rotor magnet fixed to the rotor core. The torque of the rotor 30 is transmitted to the gear mechanism 60.

The shaft 31 is rotatable about the central axis J. The shaft 31 is rotatably supported by the bearings 34 and 35. The shaft 31 is a hollow shaft. The shaft 31 has a cylindrical shape that extends axially about the central axis J. The shaft 31 is provided with a hole portion 33 that allows the inside of the shaft 31 and an outside of the shaft 31 to communicate with each other. The shaft 31 extends across the inside of the motor housing 20 and the inside of the gear housing 61. The shaft 31 has an end portion on the second axial side (+Y side) that protrudes into the inside of the gear housing 61. The shaft 31 is connected at the end portion on the second axial side with the speed reducer 62.

The shaft 31 includes a hollow first shaft portion 31a and a second shaft portion 110. In the present embodiment, the first shaft portion 31a and the second shaft portion 110 are separate bodies from each other. The first shaft portion 31a has a cylindrical shape extending axially about the central axis J. The first shaft portion 31a is open on both axial sides. The first shaft portion 31a extends across the inside of the motor housing 20 and the inside of the gear housing 61. The first shaft portion 31a is rotatably supported by the bearings 34 and 35. For example, the first shaft portion 31a may be configured by axially coupling a motor shaft positioned in the motor housing 20 and a gear shaft positioned in the gear housing 61.

As illustrated in FIG. 2, the first shaft portion 31a includes a large-diameter portion 31b and a small-diameter portion 31c. The small-diameter portion 31c communicates with the first axial side (−Y side) of the large-diameter portion 31b. The outer diameter of the small-diameter portion 31c is smaller than the outer diameter of the large-diameter portion 31b. The axial dimension of the small-diameter portion 31c is smaller than the axial dimension of the large-diameter portion 31b. The end portion on the first axial side of the small-diameter portion 31c is an end portion on the first axial side of the first shaft portion 31a. A stepped portion having a stepped surface facing the first axial side is provided between an outer peripheral surface of the large-diameter portion 31b and an outer peripheral surface of the small-diameter portion 31c.

A portion on the first axial side (−Y side) of the small-diameter portion 31c is positioned radially inside the peripheral wall portion 23b. More specifically, the portion on the first axial side of the small-diameter portion 31c is positioned radially inside the third wall portion 23e. The outer peripheral surface of the small-diameter portion 31c is disposed radially inward away from the inner peripheral surface of the peripheral wall portion 23b. The inner ring 35a of the bearing 35 is fixed to an outer peripheral surface of the small-diameter portion 31c. In the present embodiment, the axial position at the end portion on the first axial side of the small-diameter portion 31c is the same as the axial position at the end portion on the first axial side of the bearing 35. A stop ring 36 is attached to the outer peripheral surface of the small-diameter portion 31c. The stop ring 36 is disposed to oppose the second axial side (+Y side) of the inner ring 35a of the bearing 35.

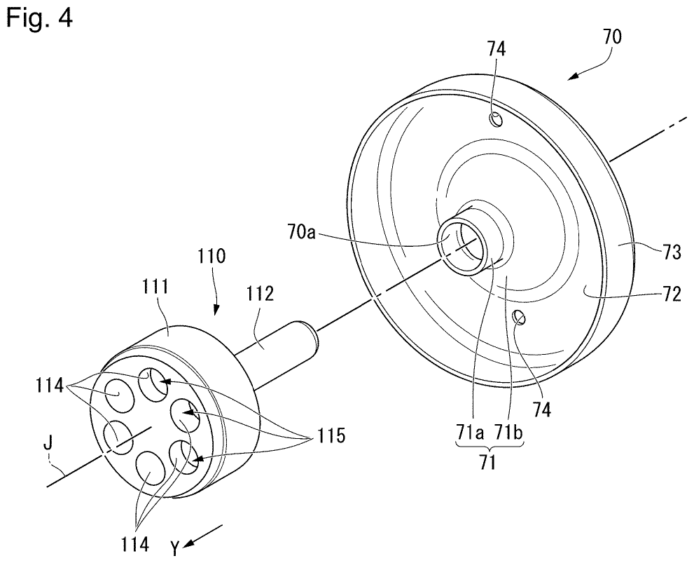

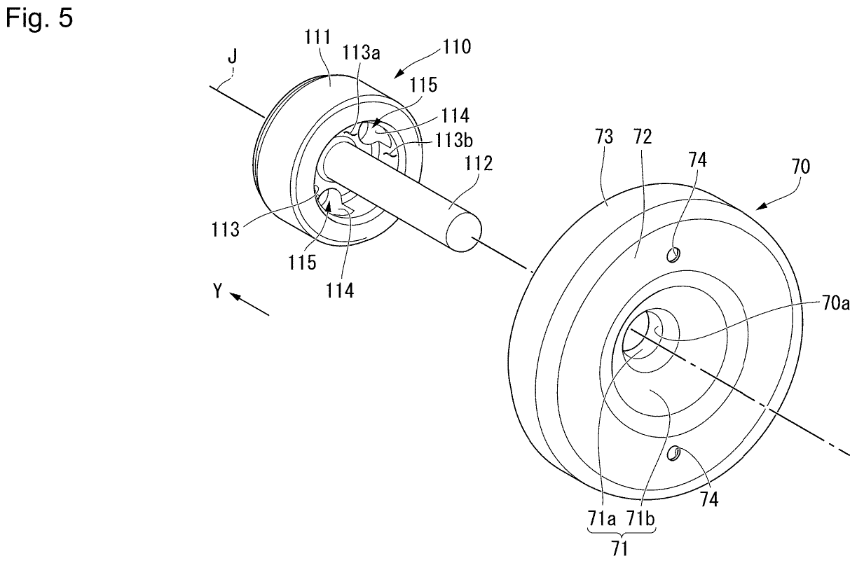

The second shaft portion 110 is coupled to the first axial side (−Y side) of the first shaft portion 31a. The second shaft portion 110 is fixed to an opening portion on the first axial side of the first shaft portion 31a. As illustrated in FIGS. 4 and 5, the second shaft portion 110 has a columnar shape extending axially about the central axis J. The second shaft portion 110 includes a lid portion 111 and an extension portion 112.

The lid portion 111 has a columnar shape about the central axis J. As illustrated in FIG. 2, the lid portion 111 is provided on a portion on the first axial side (−Y side) of the first shaft portion 31a. In the present embodiment, the lid portion 111 is provided at the end portion on the first axial side of the first shaft portion 31a. The lid portion 111 is fitted in the end portion on the first axial side of the first shaft portion 31a. The lid portion 111 is press-fitted into the first shaft portion 31a. Due to this, the second shaft portion 110 is fixed to the first shaft portion 31a.

The lid portion 111 is positioned radially inside the bearing 35. The lid portion 111 overlaps the bearing 35 in the radial direction. In other words, the lid portion 111 overlaps the bearing 35 when viewed in the radial direction. In the present embodiment, the axial position at the end portion on the first axial side (−Y side) of the lid portion 111 is the same as the axial position at the end portion on the first axial side of the first shaft portion 31a and the axial position at the end portion on the first axial side of the bearing 35. An end surface on the first axial side of the lid portion 111, an end surface on the first axial side of the first shaft portion 31a, and an end surface on the first axial side of the inner ring 35a of the bearing 35 are disposed on the identical virtual plane orthogonal to the axial direction.

The lid portion 111 has a first recess portion 113 as a recess portion recessed from the surface on the first axial side (−Y side) of the lid portion 111 to the second axial side (+Y side). As illustrated in FIG. 5, the inner peripheral edge portion of the first recess portion 113 has a circular shape about the central axis J when viewed axially. As illustrated in FIG. 2, the axial dimension of the first recess portion 113 is larger than half of the axial dimension of the lid portion 111.

The lid portion 111 has a lid portion through hole 114 axially penetrating the lid portion 111. In the present embodiment, the lid portion through hole 114 axially penetrates a portion of the lid portion 111 provided with the first recess portion 113. An end portion on the first axial side (−Y side) of the lid portion through hole 114 is open inside the first recess portion 113. As illustrated in FIG. 5, the end portion on the first axial side (−Y side) of the lid portion through hole 114 is open across a bottom surface 113a positioned on the second axial side (+Y side) of the inner surface of the first recess portion 113 and an inner peripheral surface 113b positioned on the radially outside of the inner surface of the first recess portion 113.

As illustrated in FIG. 2, the end portion on the second axial side (+Y side) of the lid portion through hole 114 is open to the end surface on the second axial side of the lid portion 111. The end portion on the second axial side of the lid portion through hole 114 is open in the first shaft portion 31a. The lid portion through hole 114 is a circular hole. The inner diameter of the lid portion through hole 114 increases toward the second axial side. The inner peripheral surface of the lid portion through hole 114 has a cylindrical shape whose inner diameter linearly increases toward the second axial side. The shape of the inner peripheral surface of the lid portion through hole 114 is similar to the outer peripheral surface of a truncated cone whose outer diameter increases toward the second axial side. The lid portion through hole 114 is positioned radially outside the central axis J. As illustrated in FIG. 4, a plurality of the lid portion through holes 114 are provided at intervals in the circumferential direction. The plurality of lid portion through holes 114 are arranged at equal intervals over the entire circumference along the circumferential direction. In the present embodiment, six of the lid portion through holes 114 are provided.

In the present embodiment, each of the lid portion through holes 114 constitutes a connection channel portion 115. That is, the shaft 31 has the connection channel portion 115. The inner peripheral surface of the connection channel portion 115 is an inner peripheral surface of the lid portion through hole 114. The connection channel portion 115 is provided in the lid portion 111. In the present embodiment, a plurality of the connection channel portions 115 are provided to surround the extension portion 112 when viewed axially. The plurality of connection channel portions 115 are arranged at equal intervals over the entire circumference along the circumferential direction. In the present embodiment, six of the connection channel portions 115 are provided.

In the present embodiment, since the connection channel portion 115 is provided in the lid portion 111, the connection channel portion 115 can be easily made by providing the lid portion through hole 114 penetrating the lid portion 111 in the axial direction. Therefore, it is easy to make the connection channel portion 115 as compared with a case where the connection channel portion 115 is provided in the extension portion 112, for example.

As illustrated in FIG. 2, the connection channel portion 115 extends in the axial direction. In the present embodiment, the connection channel portion 115 allows the inside of the first shaft portion 31a and the inside of the first recess portion 113 to communicate with each other. The connection channel portion 115 is open to the inside of the first shaft portion 31a and the inside of the first recess portion 113. In the present embodiment, the connection channel portion 115 communicates with the inside of a nozzle through hole 70a described later via the inside of the first recess portion 113. Due to this, the connection channel portion 115 communicates with the inside of the first shaft portion 31a and the inside of the nozzle through hole 70a. As illustrated in FIG. 5, the connection channel portion 115 is open across a bottom surface 113a positioned on the second axial side (+Y side) of the inner surface of the first recess portion 113 and an inner peripheral surface 113b positioned on the radially outside of the inner surface of the first recess portion 113.

As illustrated in FIG. 2, the channel cross-sectional area of the connection channel portion 115 increases toward the second axial side (+Y side). That is, the channel cross-sectional area of the connection channel portion 115 increases toward the inside of the first shaft portion 31a. In the present embodiment, the channel cross-sectional area of the connection channel portion 115 is the area inside the connection channel portion 115 in the cross section orthogonal to the axial direction. A portion positioned on the radially outside of the inner peripheral surface of the connection channel portion 115 is positioned on the radially outward toward the second axial side. That is, a portion of the inner peripheral surface of the connection channel portion 115 positioned on the radially outside is positioned on the radially outside toward the inside of the first shaft portion 31a.

The extension portion 112 extends from the lid portion 111 to the first axial side (−Y side). The extension portion 112 has a columnar shape about the central axis J. The outer diameter of the extension portion 112 is smaller than the outer diameter of the lid portion 111 and the inner diameter of the first recess portion 113. In the present embodiment, the extension portion 112 extends to the first axial side from a surface positioned on the second axial side (+Y side) of the inner surface of the first recess portion 113, that is, the bottom surface 113a. The end portion on the second axial side of the extension portion 112 is positioned in the first recess portion 113. The outer peripheral surface of the extension portion 112 is disposed radially inward away from the inner peripheral surface 113b of the first recess portion 113. The extension portion 112 protrudes to the first axial side relative to the inside of the first recess portion 113.

The extension portion 112 is axially passed through the through hole 23h. The outer peripheral surface of the extension portion 112 is disposed radially inward away from the inner peripheral surface of the through hole 23h. The end portion on the first axial side (−Y side) of the extension portion 112 is positioned inside the accommodation portion 26. The axial dimension of the extension portion 112 is larger than the axial dimension of the lid portion 111. The axial dimension of the portion of the extension portion 112 positioned on the first axial side relative to the inside of the first recess portion 113 is larger than the axial dimension of the lid portion 111.

As illustrated in FIG. 1, the stator 40 opposes the rotor 30 across a gap in the radial direction. More specifically, the stator 40 is positioned radially outward of the rotor 30. The stator 40 is fixed inside the motor housing 20. The stator 40 includes a stator core 41 and a coil assembly 42.

The stator core 41 has an annular shape surrounding the central axis J of the rotating electrical machine 10. The stator core 41 is positioned radially outside the rotor 30. The stator core 41 surrounds the rotor 30. The stator core 41 is composed of, for example, a plurality of plate members such as electromagnetic steel plates stacked in the axial direction. Although not illustrated, the stator core 41 includes a core back in a cylindrical shape extending axially, and a plurality of teeth extending to a radial inside from the core back.

The coil assembly 42 includes a plurality of coils 42c attached to the stator core 41 along the circumferential direction. The plurality of coils 42c are mounted on the respective teeth of the stator core 41 through insulators (not illustrated). The coil assembly 42 includes coil ends 42a and 42b that protrude axially from the stator core 41.

The resolver 50 can detect rotation of the rotor 30. The resolver 50 is accommodated inside the motor housing 20. The resolver 50 includes a resolver rotor 51 and a resolver stator 52. The resolver rotor 51 is fixed to the shaft 31. The resolver rotor 51 is in an annular shape surrounding the shaft 31. In the present embodiment, the resolver rotor 51 has an annular shape about the central axis J. As illustrated in FIG. 2, in the present embodiment, the resolver rotor 51 surrounds an end portion on the second axial side (+Y side) of the small-diameter portion 31c. The resolver rotor 51 has a plate shape whose plate surface faces the axial direction. The surface on the second axial side of the resolver rotor 51 is in contact with a stepped surface of the stepped portion provided axially between the large-diameter portion 31b and the small-diameter portion 31c. The resolver rotor 51 protrudes radially outward relative to the outer peripheral surface of the large-diameter portion 31b. The resolver rotor 51 is disposed at intervals on the second axial side of the bearing 35.

The resolver stator 52 is positioned radially outside the resolver rotor 51. The resolver stator 52 is in an annular shape surrounding the resolver rotor 51. The resolver stator 52 is held by the resolver holding portion 25. Although not illustrated, the resolver stator 52 includes a coil. When the resolver rotor 51 rotates together with the shaft 31, induced voltage corresponding to a circumferential position of the resolver rotor 51 is generated in the coil of the resolver stator 52. The resolver 50 can detect rotation of the resolver rotor 51 and the shaft 31 based on change in the induced voltage generated in the coil of the resolver stator 52. This enables the resolver 50 to detect rotation of the rotor 30.

The electricity removal device 80 is accommodated inside the accommodation portion 26. As illustrated in FIG. 3, the electricity removal device 80 is positioned radially outside a portion of the extension portion 112 positioned in the accommodation portion 26. The electricity removal device 80 is positioned below the extension portion 112, for example. The electricity removal device 80 includes a holder portion 81, a brush portion 82, and a fixed portion 83. In the present embodiment, the holder portion 81 has a radially long rectangular parallelepiped shape. The holder portion 81 holds the brush portion 82.

The brush portion 82 protrudes radially inward from the holder portion 81. The brush portion 82 has a substantially rectangular parallelepiped shape. In the present embodiment, the brush portion 82 is a carbon brush. The brush portion 82 is positioned radially outside the extension portion 112. The radially inner end portion of the brush portion 82 is in electrical contact with the outer peripheral surface of the extension portion 112. Due to this, the electricity removal device 80 is in electrical contact with the shaft 31. In the present embodiment, the electricity removal device 80 is in contact with a portion of the extension portion 112 positioned on the first axial side (−Y side) relative to the nozzle through hole 70a described later. The shaft 31 rotates while the outer peripheral surface of the extension portion 112 is rubbed against the radially inner end portion of the brush portion 82. In the present description, “an object is in electrical contact with another object” is sufficient if electric current can flow between the object and the other object.

The fixed portion 83 protrudes from the holder portion 81 in a direction orthogonal to both the axial direction and the direction in which the brush portion 82 protrudes from the holder portion 81. The fixed portion 83 has a plate shape whose plate surface faces the axial direction. The fixed portion 83 is made of metal. Although not illustrated, the fixed portion 83 is electrically connected to the brush portion 82 inside the holder portion 81, for example. A pair of the fixed portions 83 are provided with the holder portion 81 interposed therebetween in a direction orthogonal to both the axial direction and the direction in which the brush portion 82 protrudes from the holder portion 81. The pair of fixed portions 83 are fixed to the pair of support column portions 26d with bolts. Due to this, the electricity removal device 80 is fixed to the motor housing 20. The fixed portion 83 is in electrical contact with the motor housing 20 with the support column portion 26d interposed therebetween. Due to this, the electricity removal device 80 is in electrical contact with the motor housing 20.

As described above, since the fixed portion 83 is electrically connected to the brush portion 82, the brush portion 82 is in electrical contact with the shaft 31, and the fixed portion 83 is in electrical contact with the motor housing 20, whereby the shaft 31 and the motor housing 20 are electrically connected via the electricity removal device 80. Therefore, the current generated in the shaft 31 can flow from the support column portion 26d to the motor housing 20 through the brush portion 82 and the fixed portion 83 in this order. This makes it possible to suppress the current from flowing from the shaft 31 to the bearings 34 and 35 that rotatably support the shaft 31. Therefore, electrolytic corrosion can be prevented from occurring in the bearings 34 and 35.

The nozzle member 70 is a member for supplying the oil O as a fluid to the inside of the shaft 31. As illustrated in FIG. 2, the nozzle member 70 is formed by performing machining such as pressing on a metal plate member, for example. The nozzle member 70 is disposed inside the peripheral wall portion 23b. The nozzle member 70 is disposed away on the second axial side (+Y side) of the bottom wall portion 23a. The nozzle member 70 includes a supply tube portion 71, a flange portion 72, and a protruding tube portion 73.

The supply tube portion 71 extends in the axial direction. In the present embodiment, the supply tube portion 71 is in a cylindrical shape about the central axis J. The supply tube portion 71 is open on both axial sides. The extension portion 112 is passed through the radially inner side of the supply tube portion 71 in the axial direction. The end portion on the second axial side (+Y side) of the supply tube portion 71 is positioned in the first recess portion 113. The outer peripheral surface of the supply tube portion 71 is disposed radially inward away from the inner peripheral surface 113b of the first recess portion 113. The supply tube portion 71 includes a discharge tube portion 71a and a guide tube portion 71b.

The discharge tube portion 71a has a cylindrical shape that opens on the second axial side (+Y side) about the central axis J. The end portion on the second axial side of the discharge tube portion 71a is the end portion on the second axial side of the supply tube portion 71. An inner diameter and an outer diameter of the discharge tube portion 71a are the same over the entire axial direction. The discharge tube portion 71a is open to the inside of the first recess portion 113. A portion on the second axial side of the discharge tube portion 71a is positioned in the first recess portion 113. The end portion on the second axial side of the discharge tube portion 71a is disposed on the first axial side (−Y side) away from the bottom surface 113a of the first recess portion 113. The end portion on the second axial side of the discharge tube portion 71a axially opposes, via a gap, a portion of the bottom surface 113a of the first recess portion 113 on the radially inside relative to the portion where the connection channel portion 115 is opened. A portion on the first axial side (−Y side) of the discharge tube portion 71a is positioned on the first axial side relative to the inside of the first recess portion 113.

The guide tube portion 71b communicates with the first axial side (−Y side) of the discharge tube portion 71a. The guide tube portion 71b has a cylindrical shape that opens on the first axial side about the central axis J. The end portion on the first axial side of the guide tube portion 71b is an end portion on the first axial side of the supply tube portion 71. The inner diameter and the outer diameter of the guide tube portion 71b increase toward the first axial side. The guide tube portion 71b is a truncated cone-shaped tube whose inner diameter and outer diameter increase toward the first axial side. The outer diameter at the end portion on the second axial side (+Y side) of the guide tube portion 71b is the same as the outer diameter at the end portion on the first axial side of the discharge tube portion 71a, and is smaller than the inner diameter of the first recess portion 113. The inner diameter at the end portion on the second axial side of the guide tube portion 71b is the same as the inner diameter at the end portion on the first axial side of the discharge tube portion 71a. The outer diameter at the end portion on the first axial side of the guide tube portion 71b is larger than the inner diameter of the first recess portion 113.

The guide tube portion 71b is disposed away on the first axial side (−Y side) of the lid portion 111. The guide tube portion 71b opposes the lid portion 111 in the axial direction with a gap interposed therebetween. The guide tube portion 71b is positioned radially inside the second wall portion 23d. The opening portion on the first axial side of the guide tube portion 71b opposes the second recess portion 23g in the axial direction with a gap interposed therebetween. The axial dimension of the guide tube portion 71b is larger than the axial dimension of the discharge tube portion 71a.

The supply tube portion 71 constitutes the nozzle through hole 70a. That is, the nozzle member 70 has the nozzle through hole 70a. The inside of the nozzle through hole 70a is the inside of the supply tube portion 71. The nozzle through hole 70a penetrates the nozzle member 70 in the axial direction. The nozzle through hole 70a is a circular hole about the central axis J. The inner diameter of the portion of the nozzle through hole 70a configured by the discharge tube portion 71a is the same over the entire axial direction. The inner diameter of the portion of the nozzle through hole 70a configured by the guide tube portion 71b increases toward the first axial side (−Y side).

The extension portion 112 is passed through the nozzle through hole 70a in the axial direction. The inner peripheral surface of the nozzle through hole 70a is disposed radially outward away from the outer peripheral surface of the extension portion 112. A gap is provided over the entire circumference in the circumferential direction radially between the inner peripheral surface of the nozzle through hole 70a and the outer peripheral surface of the extension portion 112. The oil O flowing in the nozzle through hole 70a flows through a radial gap between the inner peripheral surface of the nozzle through hole 70a and the outer peripheral surface of the extension portion 112. The nozzle through hole 70a is open to the inside of the first recess portion 113. In the present embodiment, the nozzle through hole 70a communicates with the inside of the shaft 31 via the inside of the first recess portion 113 and the connection channel portion 115.

The opening portion on the second axial side (+Y side) of the nozzle through hole 70a is disposed away from the bottom surface 113a of the first recess portion 113 on the first axial side (−Y side). The opening portion on the second axial side of the nozzle through hole 70a axially opposes, via a gap, a portion of the bottom surface 113a of the first recess portion 113 on the radially inside relative to the portion where the connection channel portion 115 is opened. The inner edge in the opening portion on the second axial side of the nozzle through hole 70a is positioned on the radially inside relative to the opening portion open to the bottom surface 113a of the connection channel portion 115.

The flange portion 72 extends radially outward from the supply tube portion 71. In the present embodiment, the flange portion 72 protrudes radially outward from an end portion on the first axial side (−Y side) of the supply tube portion 71. The flange portion 72 is in an annular shape surrounding the central axis J. In the present embodiment, the flange portion 72 has an annular shape about the central axis J. The flange portion 72 has a plate shape whose plate surface faces the axial direction. The radially outer edge portion of the flange portion 72 is in contact with the first stepped surface 24c. A portion of the flange portion 72 excluding the radially outer edge portion opposes the bottom wall portion 23a in the axial direction with a gap interposed therebetween. The flange portion 72 is disposed to oppose the first axial side of the bearing 35. As described above, in the present embodiment, a part of the nozzle member 70 opposes the bearing 35 in the axial direction.

The protruding tube portion 73 protrudes from the radially outer edge portion of the flange portion 72 to the second axial side (+Y side). The protruding tube portion 73 has a cylindrical shape about the central axis J. The protruding tube portion 73 is fitted with a gap on the radially inner side of the second wall portion 23d. Due to this, the nozzle member 70 is fitted inside the peripheral wall portion 23b. The end portion on the second axial side of the protruding tube portion 73 opposes the bearing 35 in the axial direction. The end portion on the second axial side of the protruding tube portion 73 is in contact with the outer ring 35b of the bearing 35. The end portion on the second axial side of the protruding tube portion 73 is positioned on the first axial side (−Y side) relative to the end portion on the second axial side of the supply tube portion 71. The inner peripheral surface of the protruding tube portion 73 is positioned on the radial outside relative to the inner peripheral surface of the outer ring 35b of the bearing 35. At least a part of the outer peripheral surface of the protruding tube portion 73 is in contact with the inner peripheral surface of the second wall portion 23d, for example.

In the present embodiment, since the flange portion 72 is in contact with the first stepped surface 24c and the protruding tube portion 73 is in contact with the bearing 35, the nozzle member 70 is positioned axially. In the present embodiment, by disposing the bearing 35 after disposing the nozzle member 70 in the peripheral wall portion 23b, the nozzle member 70 can be fixed in the axial direction by the bearing 35. The flange portion 72 and the first stepped surface 24c may oppose each other with a gap interposed therebetween without being in contact with each other, or the protruding tube portion 73 and the bearing 35 may oppose each other with a gap interposed therebetween without being in contact with each other.

The nozzle member 70 has a penetration portion 74 axially penetrating a portion of the nozzle member 70 opposing the bearing 35 in the axial direction. In the present embodiment, a portion of the nozzle member 70 opposing the bearing 35 in the axial direction includes the flange portion 72 and the protruding tube portion 73. In the present embodiment, the penetration portion 74 is provided in the flange portion 72. As illustrated in FIGS. 4 and 5, the penetration portion 74 is a circular hole penetrating the flange portion 72 in the axial direction. A plurality of the penetration portions 74 are provided at intervals in the circumferential direction. In the present embodiment, two of the penetration portions 74 are provided radially across the central axis J. As illustrated in FIG. 2, the penetration portion 74 axially opposes the inner ring 35a of the bearing 35 with a gap interposed therebetween. The penetration portion 74 is a supply hole for supplying the oil O as a fluid to the bearing 35. The inner diameter of the penetration portion 74 is smaller than the inner diameter of the nozzle through hole 70a.

The seal member 120 has an annular shape surrounding the shaft 31. In the present embodiment, the seal member 120 has an annular shape about the central axis J. The seal member 120 is positioned radially between the shaft 31 and the motor housing 20. In the present embodiment, the seal member 120 is fixed in the large-diameter hole portion 23i of the through hole 23h provided in the bottom wall portion 23a. The seal member 120 is positioned on the first axial side (−Y side) relative to the nozzle member 70 and on the second axial side (+Y side) relative to the electricity removal device 80.

The radially outer edge portion of the seal member 120 is in contact with the inner peripheral surface of the large-diameter hole portion 23i. The radially inner edge portion of the seal member 120 is in contact with the outer peripheral surface of the extension portion 112. Due to this, the seal member 120 seals radially between the inner peripheral surface of the large-diameter hole portion 23i and the outer peripheral surface of the extension portion 112. In the present embodiment, the radially inner edge portion of the seal member 120 is elastically deformable in the radial direction, and is pressed against the outer peripheral surface of the extension portion 112 by an elastic force. In the present embodiment, the seal member 120 is an oil seal.

As illustrated in FIG. 1, the drive device 100 in the present embodiment is provided with the refrigerant channel portion 90 through which the oil O as a refrigerant circulates. The refrigerant channel portion 90 is provided across the inside of the motor housing 20 and the inside of the gear housing 61. The refrigerant channel portion 90 is a channel through which the oil O stored in the gear housing 61 is supplied to the rotating electrical machine 10 and returns to the inside of the gear housing 61 again. The refrigerant channel portion 90 is provided with a pump 96, a cooler 97, and the refrigerant supply portion 95. In the following description, an upstream side in a flow direction of the oil O in the refrigerant channel portion 90 is simply referred to as “upstream side”, and a downstream side in the flow direction of the oil O in the refrigerant channel portion 90 is simply referred to as “downstream side”. The refrigerant channel portion 90 includes a gear-side channel portion 91, an intermediate channel portion 92, and a rotating electrical machine-side channel portion 93.

The gear-side channel portion 91 includes a first portion 91a and a second portion 91b. The first portion 91a and the second portion 91b are provided in a wall portion of the gear housing 61, for example. The first portion 91a allows a portion inside the gear housing 61 where the oil O stored and the pump 96 to communicate with each other. The second portion 91b allows the pump 96 and the cooler 97 to communicate with each other.

The intermediate channel portion 92 is provided across the wall portion of the gear housing 61 and a wall portion of the motor housing 20. The intermediate channel portion 92 allows the gear-side channel portion 91 and the rotating electrical machine-side channel portion 93 to communicate with each other. More specifically, the intermediate channel portion 92 allows the cooler 97 and a third channel portion 93c described later to communicate with each other.

The rotating electrical machine-side channel portion 93 is provided in the rotating electrical machine 10. The rotating electrical machine-side channel portion 93 includes a first channel portion 93a, a second channel portion 93b, and the third channel portion 93c. That is, the rotating electrical machine 10 includes the first channel portion 93a, the second channel portion 93b, and the third channel portion 93c. The first channel portion 93a and the third channel portion 93c are provided in the wall portion of the motor housing 20. The second channel portion 93b includes a fourth channel portion 93d provided in a wall portion of the motor housing 20 and the refrigerant supply portion 95. In the present embodiment, the first channel portion 93a, the third channel portion 93c, and the fourth channel portion 93d are provided in the motor cover 23. The third channel portion 93c communicates with the first channel portion 93a and the second channel portion 93b. In the present embodiment, the first channel portion 93a and the second channel portion 93b branch from the third channel portion 93c.

The first channel portion 93a is a channel portion through which the oil O as a fluid to is supplied to inside the peripheral wall portion 23b. The first channel portion 93a has an end portion on the upstream side that communicates with an end portion of the third channel portion 93c on the downstream side. The first channel portion 93a has an end portion on the downstream side that opens to the inside of the peripheral wall portion 23b. As illustrated in FIG. 2, an end portion on the downstream side of the first channel portion 93a is open to the surface on the second axial side (+Y side) of the bottom wall portion 23a. In the present embodiment, the end portion on the downstream side of the first channel portion 93a is open inside the second recess portion 23g. The end portion on the downstream side of the first channel portion 93a is a supply port 93e for supplying the oil O into the peripheral wall portion 23b.

The first channel portion 93a opens toward an axial gap 27 between the nozzle member 70 and the seal member 120 in the motor housing 20. In the present embodiment, the axial gap 27 is a portion positioned on the first axial side (−Y side) relative to the nozzle member 70 and positioned on the second axial side (+Y side) relative to the seal member 120 in the internal space of the peripheral wall portion 23b. The axial gap 27 includes a space on the radially inside of the first wall portion 23c and an internal space of the second recess portion 23g. In the present embodiment, the first channel portion 93a corresponds to the “housing channel portion” provided in the motor housing 20.

As illustrated in FIG. 1, the second channel portion 93b is a channel portion through which the oil O as a fluid is supplied to the stator 40. An end portion on the upstream side of the fourth channel portion 93d in the second channel portion 93b communicates with an end portion on the downstream side of the third channel portion 93c. An end portion on the downstream side of the fourth channel portion 93d communicates with an end portion on the upstream side of the refrigerant supply portion 95.

In the present embodiment, the refrigerant supply portion 95 is in a tubular shape extending axially. In other words, in the present embodiment, the refrigerant supply portion 95 is an axially extending pipe. The refrigerant supply portion 95 has axially both end portions supported by the motor housing 20. The refrigerant supply portion 95 has the end portion on the second axial side (+Y side) that is supported by the partition wall portion 22, for example. The refrigerant supply portion 95 has the end portion on the first axial side (−Y side) that is supported by the motor cover 23, for example.

The refrigerant supply portion 95 is positioned radially outside the stator 40. In the present embodiment, the refrigerant supply portion 95 is positioned on the upper side of the stator 40. In the present embodiment, an orientation in which the oil O in the refrigerant supply portion 95 flows is an orientation of flowing from the first axial side to the second axial side. That is, in the flow direction of the oil O in the refrigerant supply portion 95, the first axial side is an upstream side and the second axial side is a downstream side. The refrigerant supply portion 95 has a supply port 95a for supplying the oil O as a refrigerant to the stator 40. In the present embodiment, the supply port 95a is an injection port through which the oil O having flowed into the refrigerant supply portion 95 is injected partially to the outside of the refrigerant supply portion 95. A plurality of supply ports 95a are provided.

When the pump 96 is driven, the oil O stored in the gear housing 61 is sucked up through the first portion 91a and flows into the cooler 97 through the second portion 91b. The oil O having flowed into the cooler 97 is cooled in the cooler 97, and then flows from the third channel portion 93c into the rotating electrical machine-side channel portion 93 through the intermediate channel portion 92. The oil O having flowed into the third channel portion 93c branches into the first channel portion 93a and the second channel portion 93b. As illustrated in FIG. 2, the oil O having flowed into the first channel portion 93a flows into the peripheral wall portion 23b. In the present embodiment, the oil O from the first channel portion 93a flows into the second recess portion 23g provided in the bottom wall portion 23a. The oil O from the first channel portion 93a flows into the axial gap 27.

A part of the oil O having flowed into the axial gap 27 flows into the first recess portion 113 through the nozzle through hole 70a. More specifically, a part of the oil O having flowed into the axial gap 27 flows into the first recess portion 113 through the guide tube portion 71b and the discharge tube portion 71a in this order. The other part of the oil O having flowed into the axial gap 27 from the first channel portion 93a flows to the second axial side (+Y side) relative to the flange portion 72 through the penetration portion 74. The oil O that having flowed to the second axial side relative to the flange portion 72 through the penetration portion 74 flows along, for example, the surface on the second axial side of the flange portion 72 and the inner peripheral surface of the protruding tube portion 73, and is supplied to the bearing 35. The amount of the oil O passing through the penetration portion 74 is smaller than the amount of the oil O passing through the nozzle through hole 70a.

A part of the oil O having flowed inside the first recess portion 113 flows inside the first shaft portion 31a through the plurality of connection channel portions 115. A part of the oil O having flowed into the first shaft portion 31a flows to the second axial side (+Y side) inside the first shaft portion 31a. As illustrated in FIG. 1, the oil O having flowed into the shaft 31 from the nozzle member 70 and flowing to the second axial side through inside the first shaft portion 31a passes through the inside of the rotor body 32 from the hole portion 33 and scatters to the stator 40.

As illustrated in FIG. 2, another part of the oil O having flowed inside the first recess portion 113 is discharged from the first recess portion 113 to the first axial side (−Y side) via a portion positioned on the radial outside relative to the discharge tube portion 71a of the inside of the first recess portion 113. The oil O discharged from the first recess portion 113 to the first axial side flows, for example, along the outer peripheral surface of the supply tube portion 71, the surface on the second axial side (+Y side) of the flange portion 72, and the inner peripheral surface of the protruding tube portion 73, and is supplied to the bearing 35. The amount of the oil O discharged from the first recess portion 113 to the first axial side is smaller than the amount of the oil O discharged into the first shaft portion 31a through the connection channel portion 115.

As illustrated in FIG. 1, the oil O having flowed into the second channel portion 93b flows inside the refrigerant supply portion 95 through the fourth channel portion 93d. The oil O having flowed into the refrigerant supply portion 95 is injected from the supply port 95a and supplied to the stator 40. Thus, by providing the first channel portion 93a and the second channel portion 93b, which branch from the third channel portion 93c, it is possible to suitably and easily supply the oil O sent from the inside of the gear housing 61 into the shaft 31 through the inside of the peripheral wall portion 23b and to the stator 40 from the refrigerant supply portion 95.

In the present embodiment, the oil O scraped up by the ring gear 63a partially enters a reservoir 98 provided in the gear housing 61. The oil O having entered the reservoir 98 flows into the shaft 31 from an end portion on the second axial side (+Y side). The oil O having flowed into the shaft 31 from the reservoir 98 passes through the inside of the rotor body 32 from the hole portion 33 and scatters to the stator 40.

The oil O supplied to the stator 40 from the supply port 95a and the oil O supplied to the stator 40 from the inside of the shaft 31 take heat from the stator 40. The oil O having cooled the stator 40 falls to the lower side to accumulate in a lower region in the motor housing 20. The oil O accumulated in the lower region in the motor housing 20 returns to the inside of the gear housing 61 through the partition wall opening 22a provided in the partition wall portion 22. As described above, the refrigerant channel portion 90 allows the oil O stored in the gear housing 61 to be supplied to the rotor 30 and the stator 40.

According to the present embodiment, the electricity removal device 80 is in contact with the portion of the extension portion 112 positioned on the first axial side (−Y side) relative to the nozzle through hole 70a. The seal member 120 is positioned on the first axial side relative to the nozzle member 70 and on the second axial side (+Y side) relative to the electricity removal device 80. Therefore, the seal member 120 can seal radially between the portion of the extension portion 112 positioned axially between the nozzle member 70 and the electricity removal device 80 and the motor housing 20. Due to this, the seal member 120 can suppress the oil O flowing through the nozzle member 70 from flowing to the electricity removal device 80. Therefore, it is possible to suppress the conductivity of the electricity removal device 80 from decreasing due to the oil O. Therefore, it is possible to suppress the current generated in the shaft 31 from becoming hard to flow to the motor housing 20 via the electricity removal device 80. That is, it is possible to suppress the electricity removal performance of the electricity removal device 80 from deteriorating. Therefore, for example, the electricity removal device 80 does not need to be an electricity removal device excellent in oil resistance, and the electricity removal device 80 can be easily made a relatively inexpensive electricity removal device.

In the present embodiment, the electricity removal device 80 includes a carbon brush as the brush portion 82 in electrical contact with the extension portion 112. The electricity removal device 80 having such a carbon brush is less expensive than an electricity removal device having an annular brush portion configured of a plurality of conductive fibers, for example. Therefore, the cost of the electricity removal device 80 can be reduced, and the manufacturing cost of the rotating electrical machine 10 can be reduced.

When the carbon brush is brought into contact with a portion of the shaft 31 having a relatively large outer diameter, a circumferential dimension of a portion of the outer peripheral surface of the shaft 31 against which the carbon brush is rubbed becomes relatively large. Therefore, the carbon brush is easily worn. On the other hand, in the present embodiment, the brush portion 82 is in contact with the extension portion 112. Unlike the first shaft portion 31a, the extension portion 112 does not need to flow the oil O internally, and therefore the outer diameter of the extension portion 112 can be made smaller than the outer diameter of the first shaft portion 31a. Due to this, the brush portion 82 can be brought into contact with a portion of the shaft 31 having a relatively small outer diameter. Accordingly, even when the brush portion 82 is a relatively inexpensive carbon brush, wearing of the brush portion 82 can be suppressed.

According to the present embodiment, the shaft 31 has the connection channel portion 115 communicating with the inside of the first shaft portion 31a and the inside of the nozzle through hole 70a. The first channel portion 93a as a housing channel portion provided in the motor housing 20 opens toward the axial gap 27 between the nozzle member 70 and the seal member 120 of the inside of the motor housing 20. Therefore, as in the present embodiment for example, the oil O supplied from the first channel portion 93a to the axial gap 27 can be supplied to the inside of the first shaft portion 31a via the nozzle through hole 70a and the connection channel portion 115. Due to this, the oil O can be suitably supplied to the inside of the shaft 31.

The electricity removal device 80 may be the electricity removal device 80 having excellent oil resistance, or may be an electricity removal device having relatively poor oil resistance. “The electricity removal device 80 has excellent oil resistance” means that a change caused by the electricity removal device 80 coming into contact with the oil O hardly occurs in the electricity removal device 80. The oil resistance may be evaluated by an immersion test into the oil O. In this case, the oil resistance is evaluated by change in weight and change in strength after immersion for a predetermined time. The evaluation of change in weight includes viewpoints of, for example, corrosion and swelling.

According to the present embodiment, the nozzle member 70 has the penetration portion 74 that axially penetrates the portion of the nozzle member 70 axially opposing the bearing 35. Therefore, a part of the oil O in the axial gap 27 can be supplied to the bearing 35 as lubricating oil via the penetration portion 74. Due to this, the oil O can be suitably supplied to the bearing 35.

Here, in the present embodiment, the bearing 35 is a ceramic ball bearing. Ceramic ball bearings often have a structure in which grease cannot be enclosed inside. Therefore, when the bearing 35 is a ceramic ball bearing as in the present embodiment, it is particularly important that the oil O can be supplied as lubricating oil from the outside of the bearing 35. When the bearing 35 is a ceramic ball bearing, it is possible to suppress the current generated in the shaft 31 from flowing to the bearing 35. Therefore, it is possible to suppress generation of a circulating current circulating through the shaft 31, the bearing 35, and the motor housing 20.

According to the present embodiment, the channel cross-sectional area of the connection channel portion 115 increases toward the inside of the first shaft portion 31a. Therefore, the oil O having flowed into the connection channel portion 115 from the nozzle member 70 can be easily discharged inside the first shaft portion 31a. Due to this, the oil O can be more easily supplied inside the shaft 31. In the present embodiment, the connection channel portion 115 is positioned radially outside the central axis J, and the inner peripheral surface of the connection channel portion 115 has a cylindrical shape whose inner diameter increases toward the inside of the first shaft portion 31a. Therefore, a portion of the inner peripheral surface of the connection channel portion 115 positioned radially outside is positioned radially outside toward the inside of the first shaft portion 31a in the axial direction. Due to this, when the oil O is pressed against a portion positioned on the radially outside of the inner peripheral surface of the connection channel portion 115 by the centrifugal force generated by the rotation of the shaft 31, the pressed oil O easily flows in an orientation approaching the inside of the first shaft portion 31a along the inner peripheral surface of the connection channel portion 115. Therefore, the oil O having flowed into the connection channel portion 115 can be more suitably discharged into the first shaft portion 31a.

According to the present embodiment, the lid portion 111 has the first recess portion 113 that is recessed from the surface on the first axial side (−Y side) of the lid portion 111 to the second axial side (+Y side). The end portion on the second axial side of the supply tube portion 71 constituting the nozzle through hole 70a is positioned in the first recess portion 113. The connection channel portion 115 is open to the inside of the first recess portion 113 and communicates with the inside of the nozzle through hole 70a via the inside of the first recess portion 113. Therefore, the oil O can be supplied from the supply tube portion 71 into the first recess portion 113, and the oil O can flow from the first recess portion 113 into the connection channel portion 115. Due to this, the oil O flowing in the nozzle through hole 70a can suitably flow to the connection channel portion 115. Therefore, the oil O can be more suitably supplied inside the shaft 31.

According to the present embodiment, the connection channel portion 115 is open across a bottom surface 113a positioned on the second axial side (+Y side) of the inner surface of the first recess portion 113 and an inner peripheral surface 113b positioned on the radially outside of the inner surface of the first recess portion 113. Therefore, as compared with a case where, for example, the connection channel portion 115 is open only on the bottom surface 113a, the oil O having flowed into the first recess portion 113 from the nozzle through hole 70a can be easily caused to flow into the connection channel portion 115. In particular, since the oil O having flowed into the first recess portion 113 receives a force radially outward by the centrifugal force, the oil O flowing radially outward by the centrifugal force in the first recess portion 113 easily flows into the connection channel portion 115 from the portion of the connection channel portion 115 open to the inner peripheral surface 113b.

According to the present embodiment, the extension portion 112 extends to the first axial side (−Y side) from the bottom surface 113a positioned on the second axial side (+Y side) of the inner surface of the first recess portion 113. A plurality of the connection channel portions 115 are provided to surround the extension portion 112 when viewed axially. Therefore, it is possible to easily pass the extension portion 112 through the nozzle through hole 70a while arranging the axial end portion of the supply tube portion 71 into the first recess portion 113 by providing the first recess portion 113. The oil O can be more suitably supplied into the first shaft portion 31a by the plurality of connection channel portions 115.

According to the present embodiment, the nozzle member 70 includes the flange portion 72 that extends radially outward from the supply tube portion 71 and is disposed to oppose the first axial side (−Y side) of the bearing 35, and the protruding tube portion 73 that protrudes from the radially outer edge portion of the flange portion 72 to the second axial side (+Y side). Therefore, the flange portion 72 can suppress the oil O having flowed into the axial gap 27 from flowing excessively to the bearing 35. Due to this, the oil O having flowed into the axial gap 27 can be easily supplied into the shaft 31 via the supply tube portion 71. As described above, the oil O flowing out from the inside of the first recess portion 113 to the first axial side can be suitably guided to the bearing 35 along the supply tube portion 71, the flange portion 72, and the protruding tube portion 73.

According to the present embodiment, the lid portion 111 overlaps the bearing 35 in the radial direction. Therefore, the connection channel portion 115 provided in the lid portion 111 can be disposed at a position close to the bearing 35. Due to this, the oil O leaking without flowing into the connection channel portion 115 of the oil O supplied from the nozzle member 70 can be easily supplied to the bearing 35. Specifically, in the present embodiment, the oil O leaking through the opening portion on the first axial side (−Y side) of the first recess portion 113 can be easily supplied to the bearing 35.

According to the present embodiment, the axial position at the end portion on the first axial side (−Y side) of the lid portion 111 is the same as the axial position at the end portion on the first axial side of the bearing 35. Therefore, the connection channel portion 115 provided in the lid portion 111 can be disposed at a position closer to the bearing 35. Due to this, the oil O leaking without flowing into the connection channel portion 115 of the oil O supplied from the nozzle member 70 can be more easily supplied to the bearing 35.

The present invention is not limited to the above-described embodiments, and other configurations and other methods can be employed within the scope of the technical idea of the present invention. The first shaft portion and the second shaft portion need not be separated from each other. The first shaft portion and the second shaft portion may be a part of an identical single member. When the first shaft portion is configured by axially coupling the motor shaft positioned in the motor housing and the gear shaft positioned in the gear housing, the motor shaft and the second shaft portion may be a part of an identical single member. The lid portion of the second shaft portion needs not have the recess portion into which the supply tube portion of the nozzle member is inserted. The relative positional relationship between the lid portion and the bearing is not particularly limited.

The connection channel portion provided in the shaft may have any configuration as long as the connection channel portion communicates with the inside of the first shaft portion and the inside of the nozzle through hole. The connection channel portion may be provided across the lid portion and the extension portion in the second shaft portion, may be provided across the first shaft portion and the second shaft portion, or may be provided only in the first shaft portion. The connection channel portion may have any shape. The channel cross-sectional area of the connection channel portion may be uniform over the entire connection channel portion. The connection channel portion may directly communicate with the inside of the first shaft portion and the inside of the nozzle through hole. The number of the connection channel portions is not particularly limited as long as it is one or more.

The electricity removal device may be any type of electricity removal device as long as it is in electrical contact with a shaft and a housing of a rotating electrical machine to allow a current flowing through the shaft to release to the housing. The electricity removal device may be an electricity removal device having an annular brush portion configured of a plurality of conductive fibers.

The nozzle member may have any shape as long as the nozzle member has the nozzle through hole. The penetration portion axially penetrating a portion of the nozzle member opposing the bearing in the axial direction may have any shape, or may be a notch instead of a hole. The number of the penetration portions is not particularly limited. The penetration portion needs not be provided.

The housing channel portion provided in the housing of the rotating electrical machine may be any channel portion as long as the housing channel portion opens toward the axial gap between the nozzle member and the seal member of the inside of the housing. The housing channel portion needs not be a channel portion that supplies a fluid into the axial gap between the nozzle member and the seal member of the inside of the housing. For example, the fluid may flow from the inside of the shaft to the axial gap via the connection channel portion and the nozzle through hole, and flow from the axial gap into the housing channel portion.

The fluid flowing through the housing channel portion and the fluid flowing through the nozzle member may be any type of fluid. The fluid may be an insulating liquid or may be water. When the fluid is water, the surface of the stator may be subjected to an insulation treatment. The bearing supplied with the fluid via the nozzle member may be any type of bearing.

The seal member positioned radially between the shaft and the housing may have any configuration as long as the seal member is positioned on the first axial side relative to the nozzle member and on the second axial side relative to the electricity removal device. The seal member may be any type of seal member as long as it can seal radially between the shaft and the housing.

The rotating electrical machine applied with the present invention is not limited to a motor, and may be a generator. The use of the rotating electrical machine is not particularly limited. For example, the rotating electrical machine may be equipped on the vehicle for uses other than the use of rotating the axle, or may be equipped on equipment other than a vehicle. The attitude of the rotating electrical machine when used is not particularly limited. The central axis of the rotating electrical machine may extend in the vertical direction. The configurations and methods described above in the present description can be appropriately combined within a range consistent with each other.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A rotating electrical machine comprising:
a rotor having a hollow shaft rotatable about a central axis;
a stator opposing the rotor with a gap interposed therebetween;
a housing internally accommodating the rotor and the stator;
a bearing rotatably supporting the shaft;
an electricity removal device fixed to the housing and in electrical contact with the shaft and the housing;
a housing channel portion provided in the housing;
a nozzle member having a nozzle through hole communicating with an inside of the shaft; and
a seal member positioned radially between the shaft and the housing, wherein
the shaft includes:
a hollow first shaft portion; and
a second shaft portion having a lid portion provided in a portion on a first axial side of the first shaft portion and an extension portion extending from the lid portion to a first axial side,
the extension portion is axially passed through the nozzle through hole,
the electricity removal device is in contact with a portion of the extension portion positioned on a first axial side relative to the nozzle through hole,
the seal member is positioned on a first axial side relative to the nozzle member and on a second axial side relative to the electricity removal device,
the shaft includes a connection channel portion communicating with an inside of the first shaft portion and an inside of the nozzle through hole, and
the housing channel portion opens toward an axial gap between the nozzle member and the seal member of an inside of the housing.

2. The rotating electrical machine according to claim 1, wherein
a part of the nozzle member axially opposes the bearing, and
the nozzle member includes a penetration portion axially penetrating a portion of the nozzle member axially opposing the bearing.

3. The rotating electrical machine according to claim 1, wherein a channel cross-sectional area of the connection channel portion increases toward an inside of the first shaft portion.

4. The rotating electrical machine according to claim 1, wherein the connection channel portion is provided in the lid portion.

5. The rotating electrical machine according to claim 4, wherein
the lid portion includes a recess portion recessed from a surface on a first axial side of the lid portion to a second axial side,
the nozzle member includes a supply tube portion constituting the nozzle through hole,
an end portion on a second axial side of the supply tube portion is positioned in the recess portion, and
the connection channel portion opens to an inside of the recess portion and communicates with an inside of the nozzle through hole via an inside of the recess portion.

6. The rotating electrical machine according to claim 5, wherein the connection channel portion opens across a surface positioned on a second axial side of inner surfaces of the recess portion and a surface positioned on a radially outside of inner surfaces of the recess portion.

7. The rotating electrical machine according to claim 5, wherein
the extension portion extends to a first axial side from a surface positioned on a second axial side of an inner surface of the recess portion, and
a plurality of the connection channel portions are provided to surround the extension portion when viewed axially.

8. The rotating electrical machine according to claim 5, wherein
the nozzle member includes:
a flange portion that extends radially outward from the supply tube portion and is disposed to oppose a first axial side of the bearing; and
a protruding tube portion protruding from a radially outer edge portion of the flange portion to a second axial side.

9. The rotating electrical machine according to claim 4, wherein the lid portion radially overlaps the bearing.

10. The rotating electrical machine according to claim 9, wherein an axial position at an end portion on a first axial side of the lid portion is same as an axial position at an end portion on a first axial side of the bearing.

11. A drive device comprising:
the rotating electrical machine according to claim 1; and
a gear mechanism connected to the rotating electrical machine.
